(19) United States
(12) Patent Application Publication
(10) Pub. No.: US 2008/0157609 A1
(43) Pub. Date: Jul. 3, 2008

(54) Plate spring for voice coil motor

(76) Inventor: Hung-Lin Wang, Yangmei Taoyuan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/646,509

(22) Filed: Dec. 28, 2006

(51) Int. Cl. H02K 33/00

(52) U.S. Cl. 310/28

(57) ABSTRACT

A plate spring for voice coil motor includes a flat plate having a central opening and provided around the central opening with an even number of identically shaped slits. The slits are so bent and staggered on the flat plate that the flat plate is divided into an inner movable portion and an outer fixed portion, which are connected via an even number of three-section linear elastically bendable portions. When the inner movable portion is subjected to an external force, the elastically bendable portions are elastically bent to allow the inner movable portion to move forward or backward relative to the outer fixed portion without sideward inclining; and when the external force is released, the inner movable portion is automatically and quickly returned to an original position by an accumulated restoring force of the elastically bendable portions.

### FIELD OF THE INVENTION

The present invention relates to a plate spring for voice coil motor, and more particularly to a plate spring for voice coil motor capable of providing big-distance displacement, improved elasticity, and quick restoring speed.

### BACKGROUND OF THE INVENTION

A voice coil motor (VCM) has the advantages of small volume, low power consumption, accurately actuated displacement, and low price, and is very suitable for use as a short-distance actuator in many electronic products, such as the vibrating motor for a mobile phone, the vertical displacement actuator of a magnetic head or an optical pickup, the auto-focusing actuator for a camera, etc. However, the VCM has a somewhat slow actuating and restoring speed, compared with the quick changing speed in only a few microseconds as found in most currently available electronic products. Therefore, at least one plate spring is normally included in the VCM to increase the actuating and restoring speed thereof.

FIG. 1 is an exploded perspective view of a conventional VCM used in a camera for auto focusing (AF). As shown, the VCM includes an upper cover 100, a lower cover 105, an outer frame 110 being provided at four inner wall surfaces with a magnet 115 each, an internally threaded lens holder 120 for a lens 125 to screw thereinto, two windings 126 wound around an outer side of the lens holder 120, and two plate springs 130 separately connected to an upper and a lower end of the lens holder 120. The lens holder 120 is supported by the two plate springs 130 to axially movably locate in the outer frame 110 and be surrounded by the four magnets 115. When the two windings 126 are supplied with an amount of current to thereby produce a magnetic field polarity, the lens holder 120 and the four magnets 115 mutually repulse or attract to thereby produce a push force against the lens holder 120. Being elastically supported by the two plate springs 130 in the center of the four magnets 115, the lens holder 120 is more quickly displaced forward or backward in the outer frame 110.

Please refer to FIG. 2 that is a top view of the plate spring 130 used in the voice coil motor of FIG. 1. As shown, the plate spring 130 is provided at two opposite ends with two substantially U-shaped slits 132 extended toward each other, so as to divide the plate spring 130 into an outer fixed portion 134 and an inner movable portion 136 that are connected to each other via two elastically bendable portions formed between the two U-shaped slits 132. The two plate springs 130 are separately screwed at the outer fixed portions 134 to an upper and a lower end of the outer frame 110, and at the inner movable portions 136 to the upper and the lower end of the lens holder 120.

FIG. 3 is a sectioned side view showing how the VCM using the plate springs 130 is actuated to move in the outer frame 110. When the windings 126 are supplied with an amount of current to produce a magnetic field and thereby magnetically repulse or attract the magnets 115, the lens holder 120 is caused to move forward or backward. At this point, the two elastically bendable portions between the two U-shaped slits 132 are elastically bent to allow the inner movable portions 136 of the two plate springs 130 to move along with the lens holder 120. When the lens holder 120 is released from the magnetic repulsion or attraction between the windings 126 and the magnets 115, an accumulated restoring force of the elastically bendable portions between the two U-shaped slits 132 automatically returns the inner movable portions 136 and accordingly the lens holder 120 to their original positions. Since the inner movable portion 136 is movable only via the two elastically bendable portions between the two U-shaped slits 132, a relatively large external force is required to actuate the inner movable portion 136. Moreover, the inner movable portion 136 so formed tends to become deviated and sidewardly inclined under the external force to thereby have reduced elasticity and slowed restoring speed.

It is therefore tried by the inventor to develop a plate spring that has a new structure adapted to always maintain the plate spring in an elastically balanced position, so that the problem of a sidewardly inclined inner movable portion as found in the conventional plate spring can be effectively solved to increase the restoring speed of the inner movable portion of the plate spring.

### SUMMARY OF THE INVENTION

A primary object of the present invention is to provide a plate spring for voice coil motor having elasticity balancing structure to enable balanced and improved elasticity as well as quick restoring speed, so as to effectively solve the problem of a sidewardly inclined plate spring in the voice coil motor.

To achieve the above and other objects, the plate spring for voice coil motor according to the present invention includes a flat plate having a central opening for a movable part in the voice coil motor to extend therethrough, and being provided at an area surrounding the central opening with a first slit, a second slit, a third slit, and a fourth slit; both the second slit and the fourth slit having two ends located near middle portions of the first slit and the third slit, and both the first slit and the third slit having two ends located near middle portions of the second slit and the fourth slit, such that four elastically bendable portions are formed around the central opening of the flat plate.

The four slits are identical in shape and staggeredly arranged on the flat plate. Moreover, the four slits are so bent and curved that the four elastically bendable portions are three-section linear elastically bendable portions having the same fixed width. With the four three-section linear elastically bendable portions symmetrically distributed on the flat plate, the plate spring of the present invention provides balanced and improved elasticity to increase the restoring speed thereof.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a conventional VCM used in a camera for auto focusing;

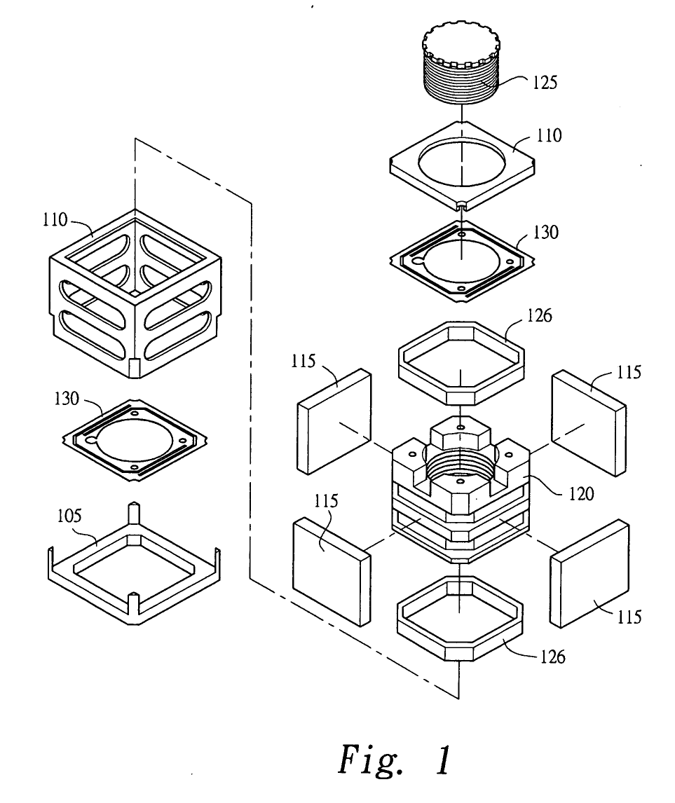

FIG. 2 is a top view of a conventional plate spring used in the VCM of FIG. 1;

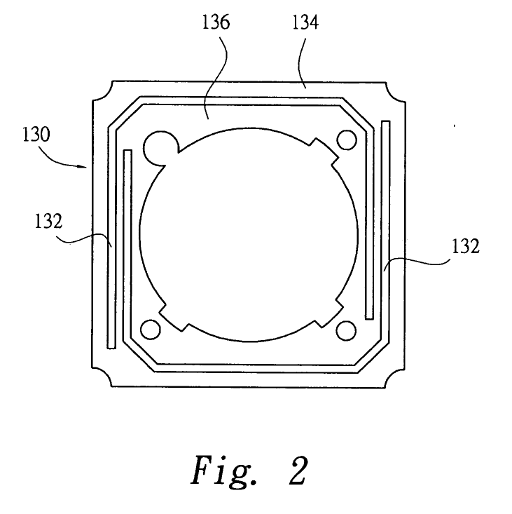

FIG. 3 is a sectioned side view showing the movement of a VCM using the conventional plate spring of FIG. 2;

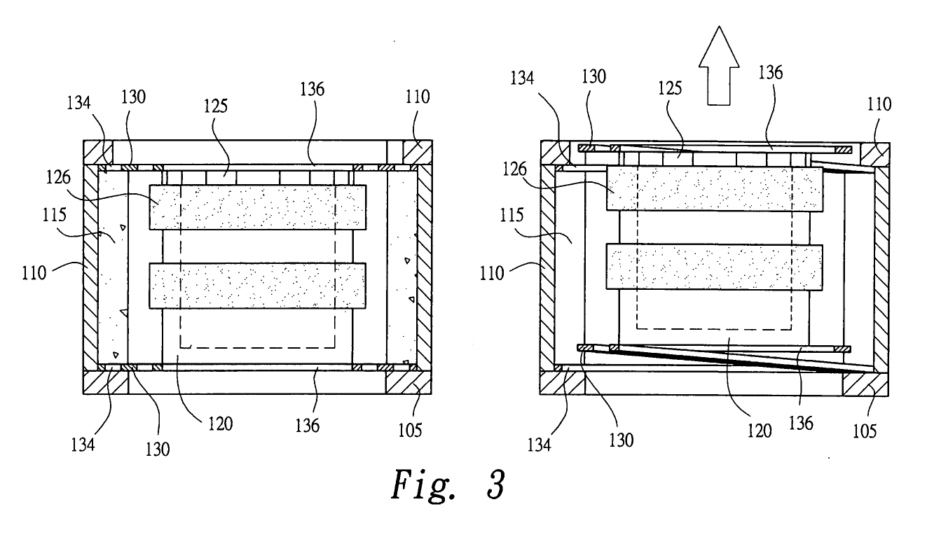

FIG. 4 is a top view of a plate spring for VCM according to the present invention; and

FIG. 5 is a sectioned side view showing the movement of a VCM using the plate spring of the present invention shown in FIG. 4.

### DETAILED DESCRIPTION OF THE PREFERRED EMBODIMENTS

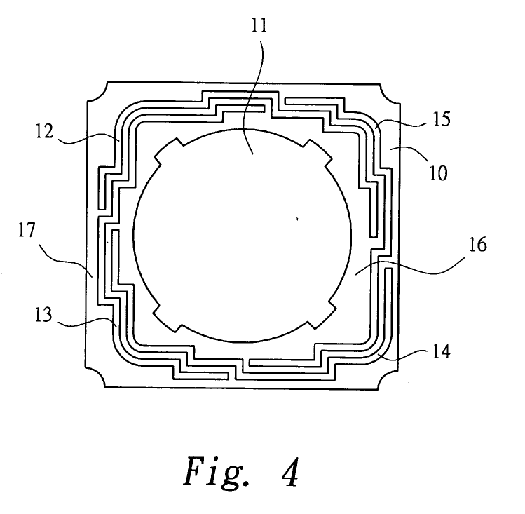

Please refer to FIG. 4 that is a top view of a plate spring for voice coil motor (VCM) according to the present invention. As shown, the plate spring of the present invention includes a rectangular flat plate 10 having a central opening 11, which may be round in shape. The rectangular flat plate 10 is provided at an area surrounding the central opening 11 with a first slit 12, a second slit 13, a third slit 14, and a fourth slit 15. Both of the second slit 13 and the fourth slit 15 have two ends located near middle portions of the first slit 12 and the third slit 14. Similarly, the first slit 12 and the third slit 14 both have two ends located near middle portions of the second slit 13 and the fourth slit 15.

Preferably, the first, the second, the third, and the fourth slit 12, 13, 14, and 15 are identical in shape, and are so bent and staggered that the rectangular flat plate 11 is divided into an inner movable portion 16 and an outer fixed portion 17 that are connected to each other via four elastically bendable portions formed on the rectangular flat plate 11 between the four slits 12, 13, 14, 15. Each of the four elastically bendable portions generally includes three continuous sections. It is also noted all the four elastically bendable portions always have the same fixed width.

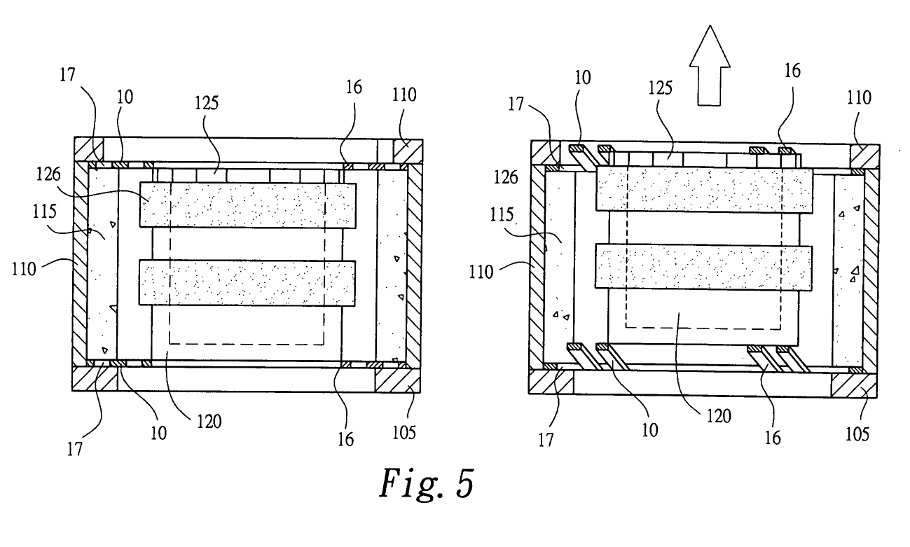

Please also refer to FIG. 5 that is a sectioned side view showing the movement of a VCM using the plate spring of the present invention shown in FIG. 4. As shown, the inner movable portion 16 is located between the central opening 11 and the four slits 12, 13, 14, 15 and screwed to an end of the lens holder 120; and the outer fixed portion 17 is located outside and around the four slits 12, 13, 14, 15, and fixedly screwed to an end of the outer frame 110. Normally, two plate springs are mounted inside the VCM and separately fixedly screwed to the upper and the lower end of the lens holder 120.

When the lens holder 120 is subjected to an external force produced by the magnetic repulsion and attraction between the windings 126 and the magnets 115, the lens holder 120 is caused to move forward or backward. At this point, the four elastically bendable portions formed between the four slits 12, 13, 14, 15 are elastically bent to allow the inner movable portions 16 of the rectangular flat plates 11 of the two plate springs to move forward and backward along with the lens holder 120 relative to the outer fixed portion 17. When the lens holder 120 is released from the magnetic repulsion or attraction between the windings 126 and the magnets 115, an accumulated restoring force of the four elastically bendable portions between the four slits 12, 13, 14, 15 automatically returns the inner movable portions 16 and accordingly the lens holder 120 to their original positions. Since the four elastically bendable portions are symmetrically distributed around the inner movable portions 16, the inner movable portions 16 is always held in an elastically balanced position to move stably.

In the rectangular flat plate 10 of the plate spring of the present invention, an even number of slits 12, 13, 14, 15 are provided and staggeredly arranged, so that four three-sectioned elastically bendable portions are formed between the inner movable portion 16 and the outer fixed portion 17 on the rectangular flat plate 10 to provide balanced elasticity to the inner movable portion 16, enabling the inner movable portion 16 to have improved elasticity and restoring force to return to its original position more quickly.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A plate spring for voice coil motor, comprising a flat plate having a central opening and being provided at an area surrounding the central opening with a first slit, a second slit, a third slit, and a fourth slit; both the second slit and the fourth slit having two ends located near middle portions of the first slit and the third slit, and both the first slit and the third slit having two ends located near middle portions of the second slit and the fourth slit, such that four elastically bendable portions are formed around the central opening of the flat plate.

2. The plate spring for voice coil motor as claimed in claim 1, wherein the first, the second, the third, and the fourth slit are identical in shape.

3. The plate spring for voice coil motor as claimed in claim 1, wherein the first, the second, the third, and the fourth slit are so bent and staggered that the four elastically bendable portions formed on the flat plate are three-section linear portions.

4. The plate spring for voice coil motor as claimed in claim 3, wherein the four elastically bendable portions always have the same fixed width.

5. The plate spring for voice coil motor as claimed in claim 1, wherein the central opening is round in shape.

6. The plate spring for voice coil motor as claimed in claim 1, wherein the first, the second, the third, and the fourth slit divided the flat plate into an inner movable portion located between the central opening and the four slits, and an outer fixed portion located outside the four slits.

7. The plate spring for voice coil motor as claimed in claim 6, wherein when the inner movable portion is subjected to an external force, the four elastically bendable portions are elastically bent to allow the inner movable portion to move forward or backward relative to the outer fixed portion; and when the external force is released, the inner movable portion is automatically returned to an original position by an accumulated restoring force of the four elastically bendable portions.
